(19) United States
(12) Patent Application Publication
(10) Pub. No.: US 2010/0136962 A1
(43) Pub. Date: Jun. 3, 2010

(54) APPARATUS, SYSTEM, AND METHOD FOR MOBILE COMMUNICATION

(75) Inventors: Guo-Qing TANG, Nanjing (CN); Biao LU, Nanjing (CN)

Correspondence Address: BRIAN M. MCINNIS, 12th Floor, Ruttonjee House, 11 Duddell Street, Hong Kong, HK

(73) Assignee: INVENTEC APPLIANCES CORP., TAIPEI HSIEN (TW)

(21) Appl. No.: 12/325,141

(22) Filed: Nov. 29, 2008

(51) Int. Cl. H04W 40/12; H04M 1/00

(52) U.S. Cl. 455/422.1; 455/552.1

(57) ABSTRACT

The invention discloses a mobile communication apparatus, for communicating with a callee or a caller through a first communication network. The mobile communication apparatus includes a communication module and a processing module. The communication module is used to connect the first communication network and a second communication network; whereas the processing module is connected to the communication module, for comparing signal quality of the first communication network with signal quality of the second communication network. Particularly, the mobile communication apparatus of the invention can switch the communication networks without hanging up the current communication.

### BACKGROUND

1. Field of Invention

The present invention relates to an apparatus, system and method for mobile communication. More particularly, the present invention relates to a mobile communication apparatus, system and method that can switch the communication networks.

2. Description of Related Art

With the widespread use of mobile communication, mobile communication apparatus, such as mobile phones, smart phones, PDAs (personal digital assistant) and so on, have become one of the indispensable assistant tools in modern life.

With the increasing numbers of service providers available, many users have multiple mobile phone numbers provided by different service providers at the same time. In the past, a mobile communication apparatus can only have a single mobile phone number at a time. Thus, when users have multiple mobile phone numbers, in order to use these numbers at the same time, they have to have multiple mobile communication apparatuses. Alternatively, users have to frequently change SIM (Subscriber Identity Module) cards in mobile communication apparatuses in order to make or receive calls with the desired mobile phone numbers.

In order to reduce the trouble of having multiple mobile phone numbers as mentioned above, mobile communication apparatuses that can have two or more SIM cards inserted are developed. Users insert two or more SIM cards into this kind of mobile communication apparatuses and switch mobile phone numbers according to the call location, signal strength, rates and so on. In this way, users do not need to purchase multiple mobile communication apparatuses or change SIM cards. They may simply configure mobile communication apparatuses to switch between phone numbers.

However, when users use the aforementioned mobile communication apparatuses to communicate and when signal strength is weakened, they need to interrupt the conversation, switch to another phone number, and re-dial. The interrupting and re-dialing process is cumbersome for users. It not only is a waste of time but affects the communication quality as well.

### SUMMARY

Therefore, this invention provides a mobile communication apparatus, system and method that can switch the communication networks. More particularly, the mobile communication apparatus, system and method according to this invention can switch the communication networks without hanging up the current communication.

According to one preferred embodiment of the present invention, a mobile communication apparatus is used to communicate with a callee or a caller through a first communication network. The mobile communication apparatus includes a communication module and a processing module. The communication module is used to connect the first communication network and a second communication network; the processing module is connected to the communication module, for comparing signal quality of the first communication network with signal quality of the second communication network.

Particularly, when the mobile communication apparatus communicates with the callee through the first communication network, the processing module sends a switch phone number to the callee through the communication module according to a criterion, and communicates with the callee through the second communication network by dialing the switch phone number. Additionally, when the mobile communication apparatus communicates with the sender through the first communication network, the processing module sends a switch request to a control center according to the criterion. The control center connects the mobile communication apparatus to the second communication network after receiving the switch request, and switches the communication between the mobile communication apparatus and the caller to the second communication network.

According to another preferred embodiment of the present invention, a mobile communication system comprises a first communication network, a second communication network and a control center. The first communication network is connected with a first mobile communication apparatus and a second mobile communication apparatus respectively, for allowing communication between the first mobile communication apparatus and the second mobile communication apparatus. The second communication network is also connected with the first mobile communication apparatus and the second mobile communication apparatus respectively, for allowing communication between the first mobile communication apparatus and the second mobile communication apparatus. The control center is connected to the first communication network and the second communication network respectively.

Particularly, when the first mobile communication apparatus and the second mobile communication apparatus communicate with each other through the first communication network, the first mobile communication apparatus compares signal quality of the first communication network with signal quality of the second communication network and sends a switch phone number to the second mobile communication apparatus according to a criterion, and communicates with the second mobile communication apparatus through the second communication network by dialing the switch phone number. Additionally, when the first mobile communication apparatus and the second mobile communication apparatus communicate with each other through the first communication network, the first mobile communication apparatus compares signal quality of the first communication network with signal quality of the second communication network and sends a switch request to the control center according to the criterion. The control center connects the first mobile communication apparatus to the second communication network after receiving the switch request, and switches the communication between the first mobile communication apparatus and the second mobile communication apparatus to the second communication network.

According to yet another preferred embodiment of the present invention, a mobile communication method is used to allow communication between a mobile communication apparatus and a callee or a caller through a first communication network. The mobile communication method comprises the following steps: (a) connecting the first communication network and a second communication network; and (b) comparing signal quality of the first communication network and signal quality of the second communication network.

Particularly, when the mobile communication apparatus communicates with the callee through the first communication network, the mobile communication method further comprises the following steps: (c1) the mobile communication apparatus sending, according to a criterion, a switch phone number to the callee; and (c2) the mobile communication apparatus communicating with the callee through the second communication network by dialing the switch phone number. Additionally, when the mobile communication apparatus communicates with the caller through the first communication network, the mobile communication method further comprises the following steps: (d1) the mobile communication apparatus sending, according to the criterion, a switch request to a control center; (d2) the control center connecting the mobile communication apparatus to the second communication network after receiving the switch request; and (d3) the control center switching the communication between the mobile communication apparatus and the caller to the second communication network.

The features and spirits of this invention will be further understood with the following detailed description and accompanying drawings.

### BRIEF DESCRIPTION OF THE DRAWINGS

FIG. 1 illustrates a block diagram of a mobile communication apparatus according to one embodiment of this invention.

FIG. 2 illustrates a block diagram of a mobile communication system according to one embodiment of this invention.

FIG. 3A illustrates a flow chart of a mobile communication method according to one embodiment of this invention.

FIG. 3B illustrates a flow chart of a mobile communication method according to one embodiment of this invention.

FIG. 3C illustrates a flow chart of a mobile communication method according to one embodiment of this invention.

### DESCRIPTION OF THE PREFERRED EMBODIMENTS

This invention provides a mobile communication apparatus, for example, but not limited to, mobile phones, PDAs with communication functionalities, handheld electronic devices with communication functionalities, or other electronic devices with communication functionalities.

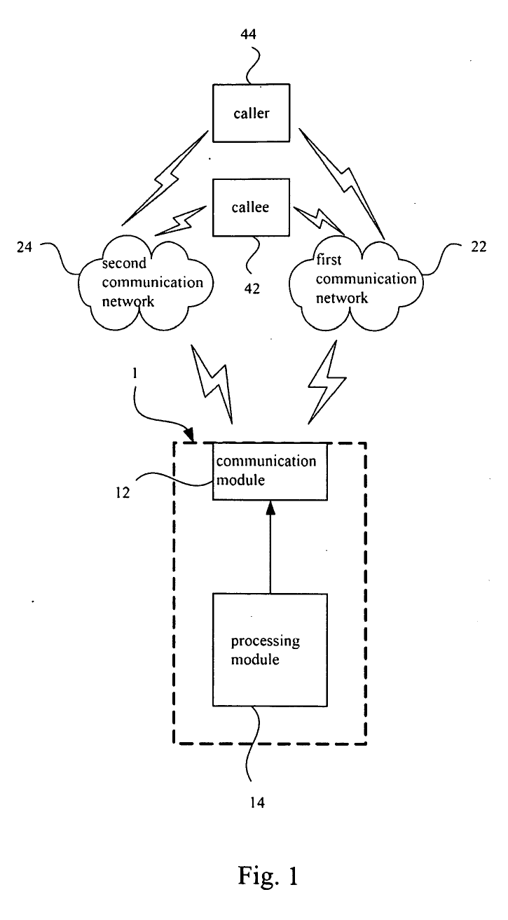

Please refer to FIG. 1. FIG. 1 illustrates a block diagram of a mobile communication apparatus according to one embodiment of this invention. As shown in FIG. 1, the mobile communication apparatus 1 may communicate with a callee 42 or a caller 44 through a first communication network 22. Moreover, the mobile communication apparatus 1 includes a communication module 12 and a processing module 14. The communication module 12 may connect the first communication network 22 and a second communication network 24. The processing module 14 is connected to the communication module 12, for comparing signal quality of the first communication network 22 with signal quality of the second communication network 24.

Particularly, in this embodiment, when the mobile communication apparatus 1 communicates with the callee 42 through the first communication network 22, the processing module 14 sends a switch phone number to the callee 42 through the communication module 12 according to a criterion, and communicates with the callee 42 through the second communication network 24 by dialing the switch phone number. In practice, the switch phone number is sent through a dual-tone multi-frequency signal.

In actual practice, the criterion might be, but not limited to, that signal quality of the second communication network be better than signal quality of the lo first communication network. Moreover, signal quality may comprise parameters such as signal strength, signal stability or other appropriate parameters.

Additionally, in this embodiment, when the mobile communication apparatus 1 communicates with the caller 44 through the first communication network 22, the processing module 14 sends a switch request to a control center (not shown) according to the aforementioned criterion. The control center connects the mobile communication apparatus 1 to the second communication network 24 after receiving the switch request, and switches the communication between the mobile communication apparatus 1 and the caller 44 to the second communication network 24.

In practice, when the processing module connects with the callee through the second communication network by dialing the switch phone number, the processing module interrupts the connection between the communication module and the first communication network. Moreover, in actual practice, when the control center switches the communication between the mobile communication apparatus and the caller to the second communication network, the control center interrupts the connection between the communication module and the first communication network.

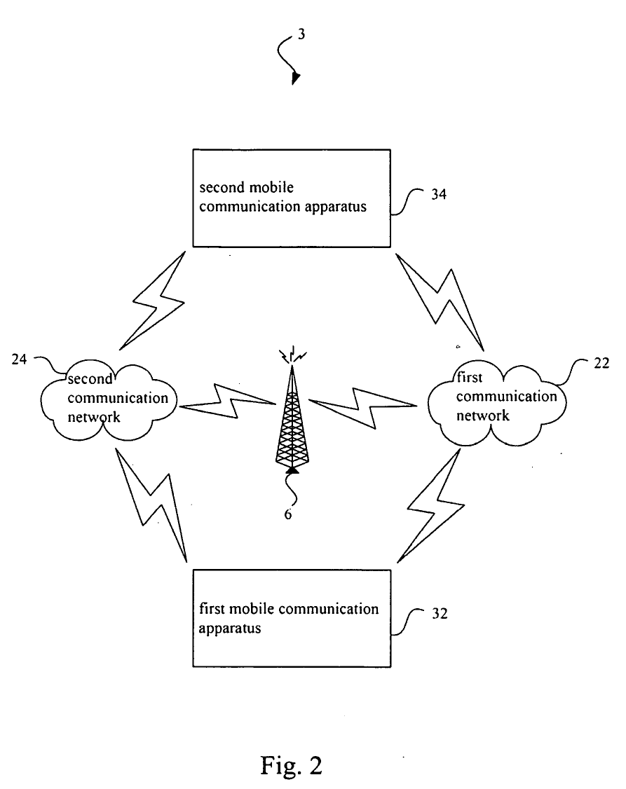

FIG. 2 illustrates a block diagram of a mobile communication system according to one embodiment of this invention. As shown in FIG. 2, the mobile communication system 3 comprises the aforementioned first communication network 22, second communication network 24 and control center 6. The first communication network 22 and the second communication network 24 are both connected with the first mobile communication apparatus 32 and the second lo mobile communication apparatus 34 respectively, for allowing communication between the first mobile communication apparatus 32 and the second mobile communication apparatus 34. Moreover, the control center 6 is connected to the first communication network 22 and the second communication network 24 respectively.

In this embodiment, when the first mobile communication apparatus 32 and the second mobile communication apparatus 34 communicate through the first communication network 22, the first mobile communication apparatus 32 may compare signal quality of the first communication network 22 with signal quality of the second communication network 24. Besides, the first mobile communication apparatus 32 sends a switch phone number to the second mobile communication apparatus 34 according to the aforementioned criterion. Then, the first mobile communication apparatus 32 communicates with the second mobile communication apparatus 34 through the second communication network 24 by dialing the switch phone number.

For instance, the first mobile communication apparatus 32 has a phone number 0911-111-000 and communicates with the second mobile communication apparatus 34 through the first communication network 22. When the first mobile communication apparatus 32 determines that signal quality of the second communication network 24, such as signal strength and/or signal stability, is better than that of the first communication network 22, it sends the switch phone number 0922-222-000 to the second mobile communication apparatus 34 through a dual-tone multi-frequency signal. After that, the first mobile communication apparatus 32 dials the switch phone number through the second communication network 24. Then, the second mobile communication apparatus 34 recognizes that the incoming number is the switch phone number 0922-222-000, so it picks up the call from the first mobile communication apparatus 32. In this way, the communication between the first mobile communication apparatus 32 and the second mobile communication apparatus 34 is switched from the first communication network 22 to the second communication network 24. Further, when the communication between the first mobile communication apparatus 32 and the second mobile communication apparatus 34 is switched to the second communication network 24, the first mobile communication apparatus 32 may interrupt the connection with the first communication network 22.

Additionally, in this embodiment, when the first mobile communication apparatus 32 and the second mobile communication apparatus 34 communicate through the first communication network 22, the first mobile communication apparatus 32 compares signal quality of the first communication network 22 with signal quality of the second communication network 24. Besides, the first mobile communication apparatus 32 sends a switch request to the control center 6 according to the aforementioned criterion. The control center 6 connects the first mobile communication apparatus 32 to the second communication network 24 after receiving the switch request, and switches the communication between the first mobile communication apparatus 32 and the second mobile communication apparatus 34 to the second communication network 24. In practice, when the control center 6 switches the communication between the first mobile communication apparatus 32 and the second mobile communication apparatus 34 to the second communication network 24, the control center 6 interrupts the connection between the first mobile communication apparatus 32 and the first communication network 22.

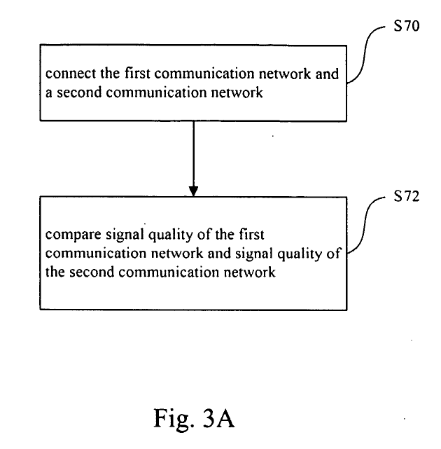

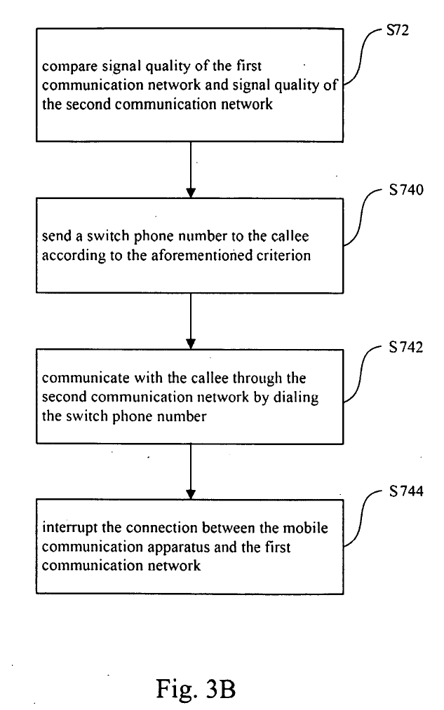

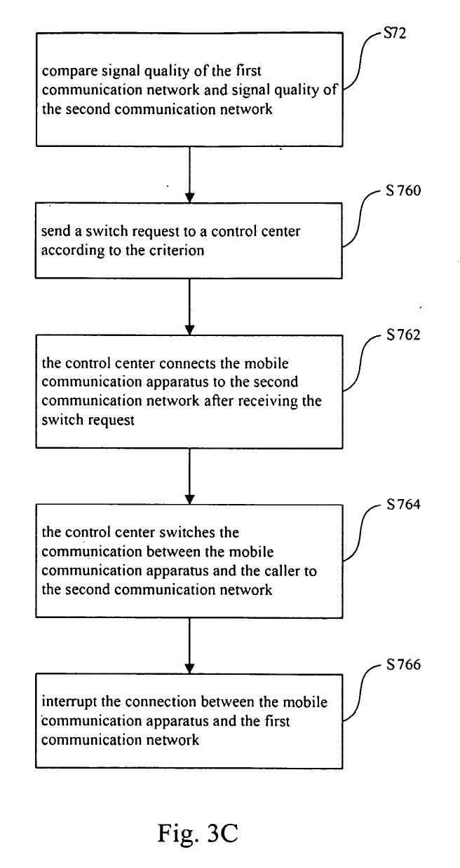

Please refer to FIG. 3A. FIG. 3A illustrates a flow chart of a mobile communication method according to one embodiment of this invention. The mobile communication method may allow communication between a mobile communication apparatus and a callee or a caller through a first communication network. As shown in FIG. 3A, the mobile communication method comprises the following steps: firstly, at step S70, connect the first communication network and a second communication network. Then, at step S72, compare signal quality of the first communication network and signal quality of the second communication network.

Please also refer to FIG. 3B. FIG. 3B illustrates a flow chart of a mobile communication method according to one embodiment of this invention. As shown in FIG. 3B, when the mobile communication apparatus communicates with the callee through the first communication network, the mobile communication method further comprises the following steps: firstly, at step S740, send a switch phone number to the callee according to the aforementioned criterion (through a dual-tone multi-frequency signal for example). Then, at step S742, communicate with the callee through the second communication network by dialing the switch phone number. After that, at step S744, interrupt the connection between the mobile communication apparatus and the first communication network.

Please also refer to FIG. 3C. FIG. 3C illustrates a flow chart of a mobile communication method according to one embodiment of this invention. As shown in FIG. 3C, when the mobile communication apparatus communicates with the caller through the first communication network, the mobile communication method further comprises the following steps: firstly, at step S760, send a switch request (a switch call) to a control center according to the criterion. Then, at step S762, the control center connects the mobile communication apparatus to the second communication network after receiving the witch request. After that, at step S764, the control center switches the communication between the mobile communication apparatus and the caller to the second communication network. Then, at step S766, interrupt the connection between the mobile communication apparatus and the first communication network. In practice, the switch request may be started through a three way calling mechanism during the communication and sent to the control center.

The above detailed description of the preferred embodiment is intended to describe the features and spirits of this invention clearly. It is to be understood that the preferred embodiments disclosed above are not necessarily limited to the specific features of this invention. Rather, it is intended that the embodiment cover modifications and variations of this invention provided they fall within the scope of the following claims and their equivalents.

1. A mobile communication apparatus, for communicating with a callee or a caller through a first communication network, the mobile communication apparatus comprising:
a communication module for connecting the first communication network and a second communication network; and
a processing module, connected to the communication module, for comparing signal quality of the first communication network with signal quality of the second communication network;
wherein when the mobile communication apparatus communicates with the callee through the first communication network, the processing module sends, according to a criterion, a switch phone number to the callee through the communication module, and communicates with the callee through the second communication network by dialing the switch phone number;
wherein when the mobile communication apparatus communicates with the caller through the first communication network, the processing module sends, according to the criterion, a switch request to a control center, the control center connects the mobile communication apparatus to the second communication network after receiving the switch request, and switches the communication between the mobile communication apparatus and the caller to the second communication network.

2. The mobile communication apparatus of claim 1, wherein the criterion is that signal quality of the second communication network be better than signal quality of the first communication network.

3. The mobile communication apparatus of claim 2, wherein the signal quality of the first or second communication network comprises signal strength and/or signal stability.

4. The mobile communication apparatus of claim 1, wherein when the processing module connects with the callee through the second communication network by dialing the switch phone number, the processing module interrupts the connection between the communication module and the first communication network.

5. The mobile communication apparatus of claim 1, wherein when the control center switches the communication between the mobile communication apparatus and the caller to the second communication network, the control center interrupts the connection between the communication module and the first communication network.

6. The mobile communication apparatus of claim 1, wherein the switch phone number is sent through a dual-tone multi-frequency signal.

7. A mobile communication system comprising:
a first communication network connected with a first mobile communication apparatus and a second mobile communication apparatus respectively, for allowing communication between the first mobile communication apparatus and the second mobile communication apparatus;
a second communication network connected with the first mobile communication apparatus and the second mobile communication apparatus respectively, for allowing communication between the first mobile communication apparatus and the second mobile communication apparatus; and
a control center connected to the first communication network and the second communication network respectively;
wherein when the first mobile communication apparatus and the second mobile communication apparatus communicate with each other through the first communication network, the first mobile communication apparatus compares signal quality of the first communication network with signal quality of the second communication network and sends, according to a criterion, a switch phone number to the second mobile communication apparatus, and communicates with the second mobile communication apparatus through the second communication network by dialing the switch phone number;
wherein when the first mobile communication apparatus and the second mobile communication apparatus communicate with each other through the first communication network, the first mobile communication apparatus compares signal quality of the first communication network with signal quality of the second communication network and sends, according to the criterion, a switch request to the control center, the control center connects the first mobile communication apparatus to the second communication network after receiving the switch request, and switches the communication between the first mobile communication apparatus and the second mobile communication apparatus to the second communication network.

8. The mobile communication system of claim 7, wherein the criterion is that signal quality of the second communication network be better than signal quality of the first communication network.

9. The mobile communication system of claim 8, wherein the signal quality of the first or second communication network comprises signal strength and/or signal stability.

10. The mobile communication system of claim 7, wherein when the first mobile communication apparatus connects with the second mobile communication apparatus through the second communication network by dialing the switch phone number, the first mobile communication apparatus interrupts the connection with the first communication network.

11. The mobile communication system of claim 7, wherein when the control center switches the communication between the first mobile communication apparatus and the second mobile communication apparatus to the second communication network, the control center interrupts the connection between the first mobile communication apparatus and the first communication network.

12. The mobile communication system of claim 7, wherein the switch phone number is sent through a dual-tone multi-frequency signal.

13. A mobile communication method, for allowing a mobile communication apparatus to communicate with a callee or a caller through a first communication network, the mobile communication method comprising the following steps:
(a) connecting the first communication network and a second communication network; and
(b) comparing signal quality of the first communication network and signal quality of the second communication network;
wherein when the mobile communication apparatus communicates with the callee through the first communication network, the mobile communication method further comprises the following steps: (c1) the mobile communication apparatus sending, according to a criterion, a switch phone number to the callee; and (c2) the mobile communication apparatus communicating with the callee through the second communication network by dialing the switch phone number;
wherein when the mobile communication apparatus communicates with the caller through the first communication network, the mobile communication method further comprises the following steps: (d1) the mobile communication apparatus sending, according to the criterion, a switch request to a control center; (d2) the control center connecting the mobile communication apparatus to the second communication network after receiving the switch request; and (d3) the control center switching the communication between the mobile communication apparatus and the caller to the second communication network.

14. The mobile communication method of claim 13, wherein the criterion is that signal quality of the second communication network be better than signal quality of the first communication network.

15. The mobile communication method of claim 14, wherein signal quality of the first or second communication network comprises signal strength and/or signal stability.

16. The mobile communication method of claim 13, wherein when the mobile communication apparatus communicates with the callee through the second communication network, the mobile communication method further comprises the following step: (c3) interrupting the connection between the mobile communication apparatus and the first communication network.

17. The mobile communication method of claim 13, wherein when the mobile communication apparatus communicates with the caller through the second communication network, the mobile communication method further comprises the following step: (d4) interrupting the connection between the mobile communication apparatus and the first communication network.

18. The mobile communication method of claim 13, wherein the switch phone number is sent through a dual-tone multi-frequency signal.
